(19) United States
(12) Patent Application Publication
(10) Pub. No.: US 2010/0226438 A1
(43) Pub. Date: Sep. 9, 2010

(54) Video Processing Systems, Methods and Apparatus

(75) Inventors: Steven E. Saunders, Cupertino, CA (US); John D. Ralston, Portola Valley, CA (US); Bjorn S. Hori, Albany, CA (US); Minqiang Jiang, Campbell, CA (US)

Correspondence Address: Law Offices of Wayne Jones, 2225 East Bayshore Road, Suite 250, Palo Alto, CA, 94303, US

(73) Assignee: Droplet Technology, Inc., Palo Alto, CA (US)

(21) Appl. No.: 12/700,719

(22) Filed: Feb. 4, 2010

Related U.S. Application Data
(60) Provisional application No. 61/149,700, filed on Feb. 4, 2009.
(60) Provisional application No. 61/162,253, filed on Mar. 20, 2009.

(51) Int. Cl. H04N 7/32; H04N 7/26

(52) U.S. Cl. 375/240.16; 375/240.01; 375/E07.026; 375/E07.243

(57) ABSTRACT

Video compression and decompression that produces a desirable balance of compression rate and picture quality while, at the same time, reducing an average number of computational cycles required to achieve the desired picture quality and compression rate. Also disclosed are video processing platforms, systems and methods that produce a quality and bits per frame performance for more widespread use of video data exchanges using standardized computer architectures, such as cellular phones having non-video optimized processing platforms.

### CROSS-REFERENCE TO RELATED APPLICATIONS

This application claims priority to U.S. Provisional Patent Application 61/149,700, filed on Feb. 4, 2009, and U.S. Provisional Patent Application 61/162,253, filed on Mar. 20, 2009; the contents of both are incorporated herein by reference.

### FIELD OF THE INVENTION

The present invention relates to the processing, sending and receiving of video data.

### BACKGROUND OF THE INVENTION

A video compressor/de-compressor (CODEC) is used to reduce the data rate needed for communicating streams of, or memory storage requirements for video data. Data rate reduction requires, in-part, a good understanding of the types of information in the original signal that are not needed to reproduce a desired image quality. By selectively removing information from the original signal, typically using heuristic rules applied as low, high, or band pass filters to data previously transformed into a spatial-frequency-domain, and by reducing the precision of the transformed data typically by operation of a quantizer, data rates may be dramatically decreased and/or storage requirements decreased.

Generally speaking, there are three competing concerns that are design drivers for video playback/capture systems: image quality, bit rate and cost/power requirements on the processor or related hardware. In many cases the underlying CODEC used in video playback/capture systems is geared primarily to addressing image quality and bit rate, but without much consideration of the impact this design approach might have on cost/power demands of the hardware used to implement the CODEC. It is often assumed that increased cost/power demands associated with implementing the CODEC can be met by increasing the basic throughput at the hardware level. Consequently, many video playback/capture systems may be regarded as hardware-implemented, dependant or reliant solutions to video processing because the logic for reducing bite-rate and/or improving image quality more or less assumes that the hardware that runs the CODEC can accommodate any increased throughput demands; thereby avoiding a concomitant and unacceptable increase in processor clock rate, computation time, heat generation and/or power draw when video data is being processed using the CODEC. And if the current hardware is not up to the task, then these video playback/capture solutions tend to conclude that application specific hardware is the answer, or they otherwise seek ways to improve upon an application specific IC design for processing video data. Examples of hardware-implemented video playback/capture systems include media-focused desktop PCs, professional workstations, e.g., as used in the movie making industry. Mobile products include media-optimized laptops, camcorders and media players such as portable DVD players.

A well-known family of standards for video CODECs is the MPEG family, including at least MPEG-1, MPEG-2, MPEG-4 Visual, and MPEG-4 AVC (also named H.264). This video compressor family uses block-based processing. It compresses video data that is transformed into a spatial frequency domain using a discrete cosine transform (DCT). Because of the computational complexities associated with implementing DCT on full-sized video frames, all known video CODECs in the MPEG family of video CODECs (MPEG-2, MPEG-4, H.264) segment each frame of video into smaller blocks (typically 16×16 pixels) before carrying out the DCT. The most recent standard block-based video compression, H.264, uses additional “de-blocking filters” added to both the decoder (to smooth out the block edges in the final image) and the encoder. See e.g. Weigand, T. et al. Overview of the H.264/AVC Video Coding Standard, IEEE TRANSACTIONS ON CIRCUITS AN SYSTEMS FOR VIDEO TECHNOLOGY, Vol. 13, No. 7, July 2003.

In order to take advantage of similarities between neighboring groups of frames (“temporal redundancy”), MPEG CODECs utilize a process of motion estimation and motion compensation to predict areas in one frame based upon surrounding, previously-coded pixels within the same frame (intra-frame prediction), or based upon similar areas in other frames (inter-frame prediction). Once this processing has been completed for an individual block, e.g., a 16×16 macro-block, a DCT is applied to that block separately from all other blocks. Inter-frame prediction gives rise to a Group of Pictures (GOP) consisting of an “Initial Frame”, or I-Frame, followed by one or more (typically 14) “Predicted Frames”, or P-frames.

The encoder subtracts the predicted areas from the actual areas to calculate a set of “residuals”, applies a DCT to each block of residuals, quantizes them, entropy encodes them, and then transmits the result together with the corresponding motion vectors that describe how each area moves in time from frame-to-frame. Since many fewer bits are typically required to encode/transmit the motion vectors and residuals than would be required to represent the areas themselves, motion estimation enables significantly higher compression levels than independent spatial-only compression of individual frames. MPEG-style motion estimation can require a high number of computational cycles to calculate all of the motion vectors and residuals for the very large number of areas into which each video frame must be divided for efficient motion estimation.

Products that do video processing can use specialized processors or standard processors. For example, a hardware platform for video intensive mobile products, e.g., a camcorder, may include a video-optimized system on chip including an ASIC core processor, multimedia processor, video-processor memory and DSP. This type of hardware generally incorporates circuitry specialized to compute parts of the MPEG compression process such as motion search comparisons, DCT steps, and the like. This type of hardware often incorporates circuitry for calculating many intermediate results or final results in parallel, by simultaneous operation of separate circuit elements. The computations implemented are typically used in no context other than image and video compression; they are specialized for compression. A standard, non-application specific hardware, or low-end imager hardware, such as general purpose CPUs, arithmetic processors, and computers, for example, uses circuitry to implement instructions and operations generally useful for many kinds of computational tasks; they are general purpose, not specialized for compression.

Image quality may be represented by the peak-signal-to-noise ratio (PSNR) of the luma component of the video frame. The compression rate, e.g., bits per frame or per pixel, is often expressed directly or indirectly with the image quality parameter. Other measures for evaluating are SSIM, VQM, and PDM. Similar standards for assessing compression quality or bite rate are set forth or endorsed by the Video Quality Experts Group (VQEG). See http://www.its.bldrdoc.gov/vqeg (downloaded Nov. 26, 2008). See also Stefan Winkler, Digital Video Quality (Wiley, 2005, ISBN 0-470-02404-6).

### SUMMARY OF THE INVENTION

The invention is directed to video processing associated with video capture/playback devices or systems. Specifically, the invention provides, in one respect, a capability for processing captured video to provide high quality video at desirable data rates but without a concomitant increase in computational cycles; or equivalently, a significant decrease in computational cycles without a noticeable degradation in video quality or increase in the data rate.

In another respect, the invention provides a process that enables practical use of multiple-purpose hardware that matches the performance levels of what has heretofore been thought only possible when using imagers that carry ASIC chips or processors with circuitry specialized for compression operations, or when using the computing power of a workstation, media-optimized PC, video game consoles, or other video-specific or high performance computing platforms.

In another respect, a mobile device including a multi-purpose, or non-video-optimized hardware platform, e.g., a mobile phone carrying a standard RISC chipset such as an ARM architecture processor is capable of producing with less computational cycles an encoded video stream that when decoded produces a high quality and bit rate standard previously met only with higher-end or video-optimized hardware platforms.

In one aspect, the invention makes use of a CODEC that implements an inter-frame and intra-frame motion estimation/compensation encoding logic. The video encoding is intended to reduce the amount of information needed to recreate a video frame by expressing video data in terms of the changes in the underlying pixel data. The techniques therefore operate under the assumption that a substantial amount of information in one video frame to the next is both temporally redundant (meaning, by analogy, that objects tend to move within a picture but not appear or disappear) and spatially redundant (meaning that blocks adjacent to previously-matched, temporally redundant blocks are likely to have as their best matches and/or predictors the blocks adjacent to the temporally-redundant block from the prior frame). For purposes of this application, the former technique is known as “intra-frame” motion estimation/compensation and the later technique “inter-frame” motion estimation/compensation. Frames encoded by motion estimation/compensation are represented by a collection of blocks and associated motion vectors. Each block contains only the differences in pixel values with its spatially or temporally redundant block from prior frame(s). For purposes of this application, each such difference is called a residual and such block is called a residual block.

According to another aspect, the motion vector defines a relative change in position of a block between the current frame and a prior frame. A frame encoded, at least in part, by inter-frame motion estimation/compensation is called a “predicted frame”. In a known method, such as H.264 or its predecessors, residuals are transformed within an arbitrarily defined portion of the frame, known as a macro-block (typically 16×16), but not the entire frame. A DCT encoding of a frame as macro-block-limited residuals and motion vectors can produce noticeable discontinuities at the edges of blocks. To counter this undesirable effect on image quality, block-based methods apply a de-blocking or smoothing function at the edges of adjacent blocks.

As noted above, an “initial frame” or “I-frame” is the first frame of video data or, more generally, the first frame of a group of pictures (GOP). A “predicted frame” or “P-frame” is any of the frames that follow the initial frame within the GOP, which are encoded at least in part by motion estimation/compensation.

With regard to the present invention, an innovative aspect of the invention is called a “thumbnail”, which is the product of successive low-pass spatial-frequency filters applied to a video frame. The filters may correspond to a complete, or partial transform of the video frame, e.g., a wavelet transform. FIG. 1 depicts a thumbnail portion of a transformed video frame after four high-low pass wavelet filter pairs are applied. The first two filter pairs generate low-low, low-high, high-low and high-high subband blocks labeled as “SB I”, “SB II”, “SB III” and “SB IV”, respectively. The second two filter pairs generate respective low-low, low-high, high-low and high-high blocks of the “SB I” subband. The thumbnail in this example corresponds to the low-low block of the original low-low block (SB I). With regard to the present invention, an innovative aspect of the invention is called a “sketch”, which is, in one embodiment, everything in the transformed video frame except the thumbnail. Thus, for example, the sketch for the transformed video frame of FIG. 1 is the SB II, SB III and SB IV blocks, and the low-high, high-low and high-high blocks of the SB I subband, i.e., everything but the low-low block of the BS I subband.

With regard to the present invention, an innovative aspect of the invention is called a “predicted thumbnail”, which is a thumbnail encoded by motion estimation/compensation. The encoded thumbnail is represented by a collection of residuals and associated motion vectors.

With regard to the present invention, an innovative aspect of the invention is called a “reference thumbnail”, which is a thumbnail from a previously encoded video frame that will be used as the reference for motion estimation/compensation encoding of the current thumbnail. Embodiments of the disclosure use a transformed, then quantized, then de-quantized, then inverse-transformed version of the thumbnail, not the actual thumbnail resulting from a transform. By using a post-quantization version of the thumbnail, the motion estimation/compensation computation is based on the same information, or lack of information that the decoder has when reconstructing the thumbnail with the transmitted residual and motion vectors. See FIG. 3B.

According to another aspect of the invention, a video compression technique improves on, or at least maintains a desired PSNR and bits per pixel, or frame, while reducing the computational cycles needed to achieve the target PSNR and bits per pixel. Quite surprisingly and unexpectedly, it was found that there were significantly less computational cycles needed to produce a desired PSNR and bits per pixel rate when incorporating principles of the invention.

According another aspect of the invention, a motion estimation/motion compensation aspect of an encoder is applied to a low pass subband of a spatial-frequency domain or transform space, as opposed to the raw image data, e.g., as in the case of H.264. In one embodiment, the low pass subband transform space is a low-low subband of a wavelet transform space. Motion estimation and motion compensation is applied to this low pass subband, which is a type of thumbnail.

According to another aspect of the invention a spatial transform of residuals is computed across an entire residual image, without interruption by blocks or macro-blocks. In one embodiment the residual image is derived from a subband representation of the entire image in the wavelet transform space.

According to another aspect of the invention, a video stream is encoded using motion estimation/compensation and without applying a de-blocking or smoothing function before encoding the video stream, wherein the decoded video stream displays no edge effects, which are caused by DCT or other transform computations performed within a macro-block.

According to another aspect of the invention, the average ratio of computational cycles between a CODEC according to the disclosure and an optimally tuned CODEC according to the prior art is decreased by a factor ranging from 2 to 100 without violating a PSNR or bits per pixel performance requirement. A factor ratio of 2 or 5 or 10 or 20 reduction in computational cycles may be achieved while maintaining a PSNR above 30 dB and bits per pixel between about 0.05 to 0.25.

According to another aspect of the invention, video signal data capable of producing a video sequence includes a first portion representing the higher spatial frequencies of a video frame and a second portion representing only a portion of the lower spatial frequencies of the video frame, wherein the video frame is reconstructed by combining the second portion and a similar portion of a prior frame, and then applying an inverse transform to the combination and the first portion.

According to another aspect of the invention, video data is encoded by performing a first transform that outputs a thumbnail and sketch. A second transform then encodes only the thumbnail as a residual and motion vector.

According to another aspect of the invention, a video frame stored on computer readable media is decoded by performing a first inverse transform that outputs a residual and motion vector representation of a thumbnail. The residual and motion vector are combined with a reference thumbnail to produce a predicted thumbnail for the video frame. An inverse transform, which receives as input the predicted thumbnail and sketch, then produces a decoded, predicted frame.

According to another aspect of the invention, software implementing a CODEC that performs motion estimation/motion compensation only on the thumbnail portion of a transformed video frame is stored on computer-readable media of a mobile device that is devoid of an application specific integrated circuit (ASIC). The mobile device may be a laptop, cellular phone, media player, MP3, VVoIP (video plus voice over IP) or a camcorder.

According to another aspect of the invention, a mobile device includes a CODEC for performing compression of video data. The CODEC runs on a non-video optimized processor and is configured to produce VGA (640×480 pixel) frames at a rate of 30 fps at 800 kilobits per second (Kb/s) average transmission. The platform includes a System on Chip (SOC) video imager, wherein the SOC is devoid of a video-ASIC. The platform may consist essentially of the video imager that receives incoming photons, a RISC processor, and a video processing memory which together encode a video stream. The RISC processor may consist of an ARM CPU.

### LISTING OF APPENDICES

The information contained in, APPENDIX B, APPENDIX C, APPENDIX D enclosed herewith, is part of the disclosure of this application.

APPENDICES B.1 and B.2 provide numerical results for various stages of processing of video signals using a CODEC, and bar chart showing the total cycles for QCIF and VGA picture size.

APPENDIX C: explains the procedure used to convert a standard “SUZIE” video clip to a modified “New-Suzie” video clip, which was used to evaluate the performance of a CODEC made in accordance with one or more of the following principles of invention.

APPENDIX D: Measurement platform for reproduction of results shown in APPENDIX B

### BRIEF DESCRIPTION OF THE DRAWINGS

FIG. 1 is a schematic representation showing a transformation of a video frame into high and low subbands. The lowest subband, depicted as “Low-Low of SB I” (the upper left hand block of the image), is used for motion estimation and motion compensation according to two of the disclosed embodiments of a CODEC. In one embodiment motion estimation/compensation is performed over the “Low-Low of SB I” subband. In this case motion estimation/compensation is performed on a thumbnail of the image. In another embodiment “Low-Low of SB I” is further transformed into two or more subbands before motion estimation/compensation is performed. In this embodiment, motion estimation/compensation is performed on a “subbands block”, as opposed to a “thumbnail”.

FIG. 2A is a schematic representation of a process associated with a video encoder adapted for encoding an initial frame of an incoming stream of uncompressed video data.

FIG. 2B is a schematic representation of a process associated with a video encoder adapted for encoding a predicted frame of the incoming video data of FIG. 2A. The output of the processes depicted in FIGS. 2A and 2B may be data packets communicated over a packet-switched network.

FIG. 3A is a schematic representation of a process associated with a video decoder adapted for decoding the data contained in the output from the process of FIG. 2A.

FIG. 3B is a schematic representation of a process associated with a video decoder adapted for decoding the data contained in the output from the process of FIG. 2B.

FIGS. 4A and 4B are plots illustrating results achieved in accordance with some embodiments of the invention. The figures show the Peak Signal-to-Noise Ratio (PSNR) for well-known test sequences known as “Suzie” and “Football”. A significant advantage of aspects of the invention is that high PSNR values vs. bit rate values such as shown in FIGS. 4A, 4B can be achieved, even by use of a standard processor (and, even by use of a relatively low complexity, general purpose processor on a mobile phone) by a significantly lower number of cycles or computational load, as compared to any previous systems.

### DETAILED DESCRIPTION OF THE INVENTION

A video encoder according to the disclosure applies a transform, or partial transform, to a video frame. In one embodiment the transform is a wavelet transform. One or more successive wavelet filter pairs are applied to a video frame. A thumbnail and sketch of the video frame is produced from this transform. Motion-estimation/compensation encoding is then applied to the thumbnail in order to obtain a representation of the thumbnail as a collection of residuals and associated motion vectors. The residuals are collectively transformed a second time, e.g., by applying a wavelet transform to the residual. After subsequent quantization and entropy encoding an encoded thumbnail and sketch are the output of the encoder.

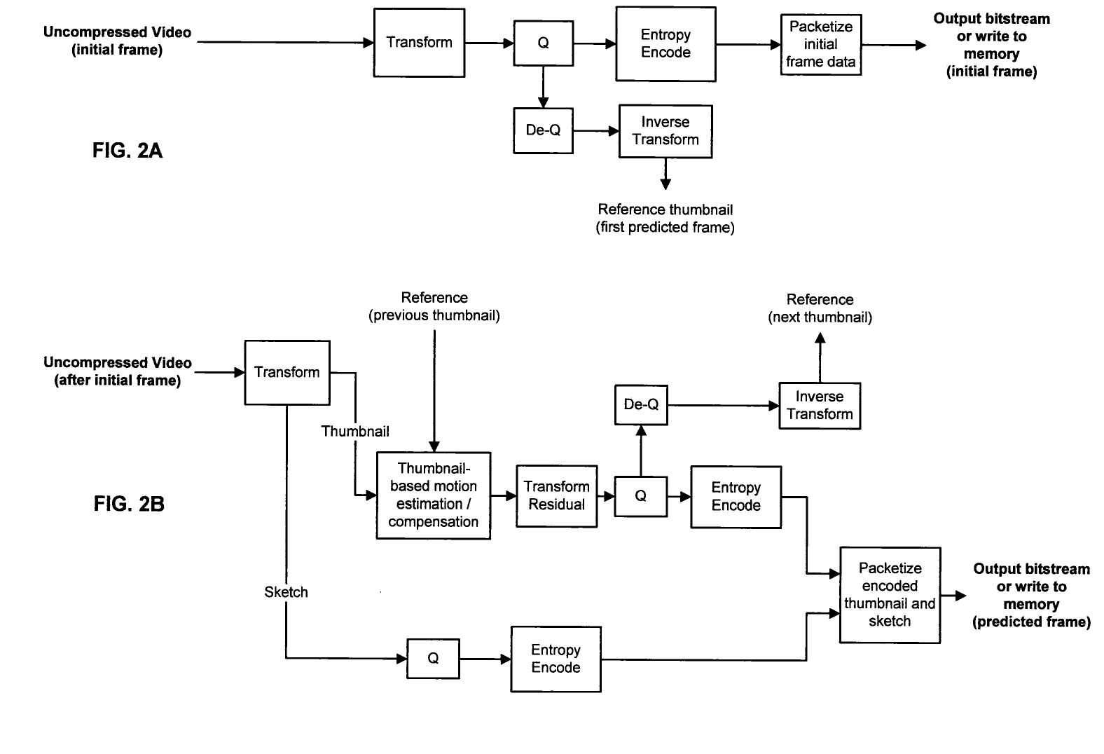

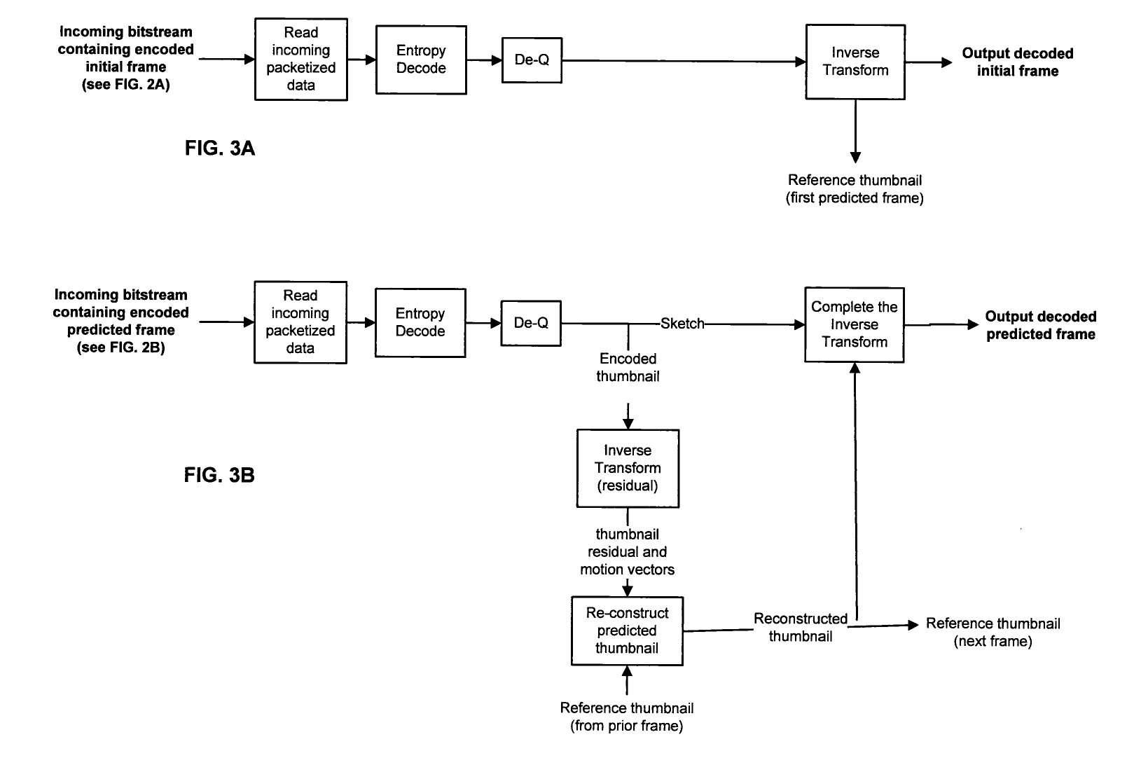

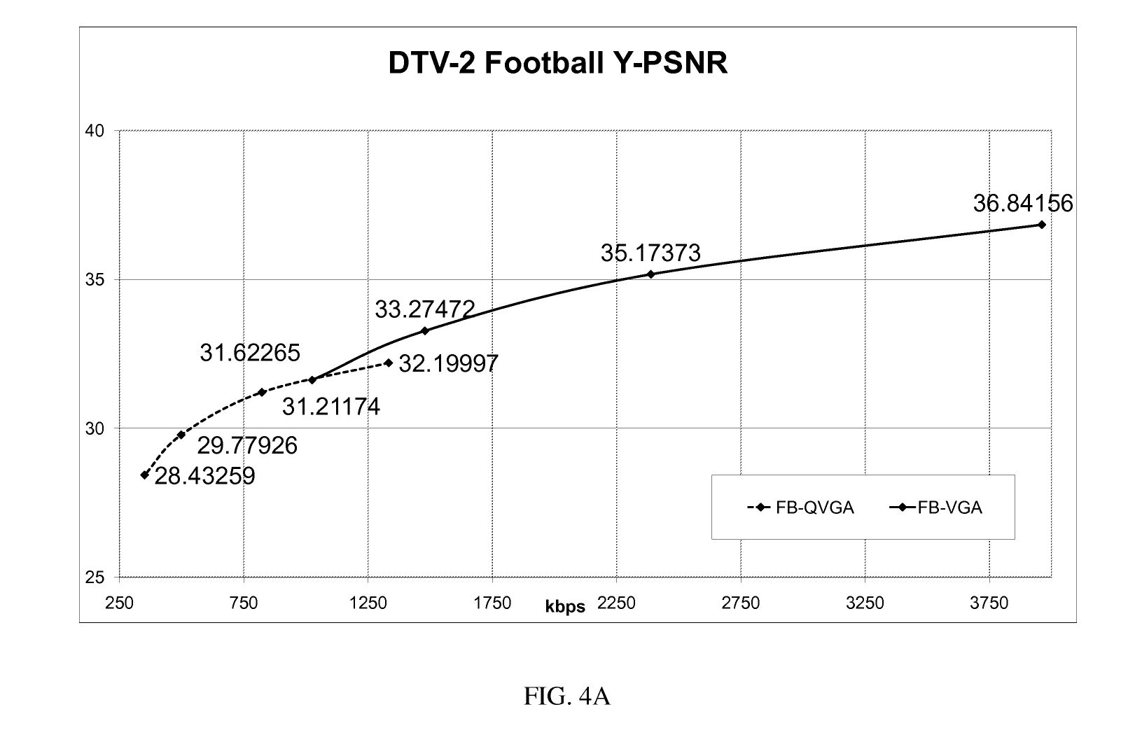

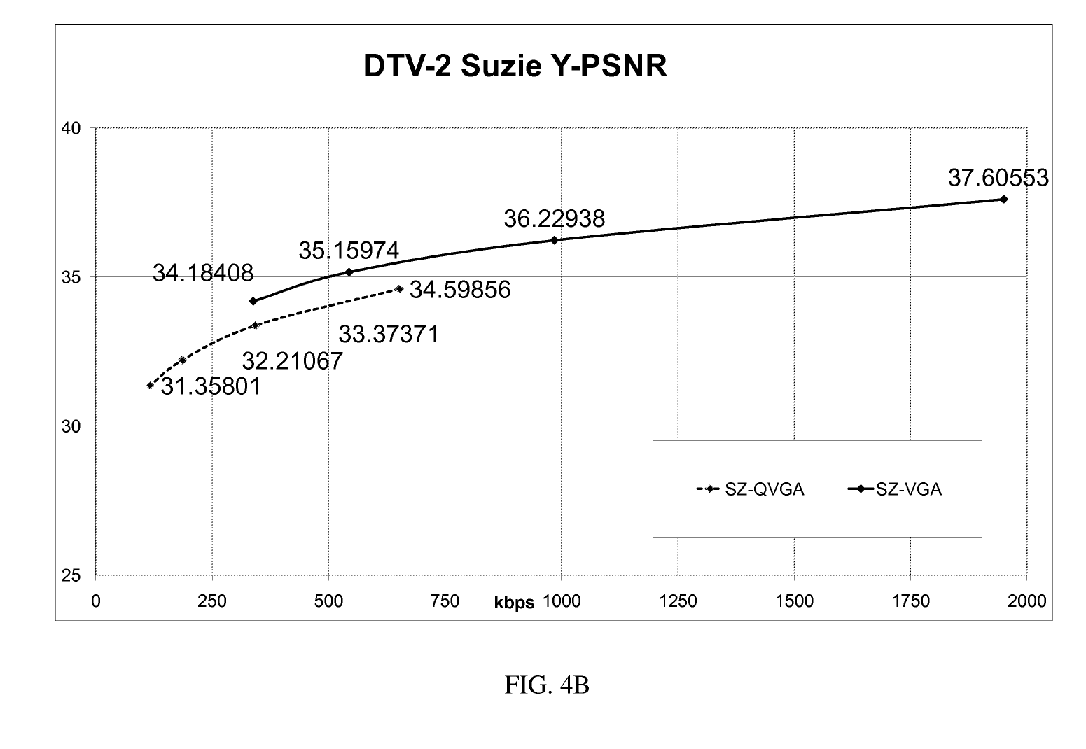

FIGS. 2A-2B depict, schematically, a description of the principal steps associated with encoding incoming video data according to the disclosure. The encoder's processing of the initial video frame is depicted in FIG. 2A, while the processing of subsequent video frames is depicted in FIG. 2B. It will be understood that the depictions in FIGS. 2A-2B do not necessarily convey a particular organization of software-implemented logic or association of hardware. Rather, the process is organized simply as one way of expressing aspects of the aforementioned principles of invention. It will be further understood that an actual software or hardware implementation may take many different forms without deviating substantially from the principle aspects of an encoder according to the invention.

Referring to FIG. 2A, since the I-frame is the first frame of the video sequence, or a GOP, the encoder may utilize logic that is substantially the same as that used for processing a still image. Thus, successive wavelet filter pairs may be applied to the frame, followed by quantization and then entropy encoding. There is an additional step associated with the process in FIG. 2A. A de-quantized thumbnail is extracted from the partially or fully transformed frame.

Following entropy encoding, a copy of the quantized video frame is de-quantized (as indicated by block “De-Q” in FIG. 2B). In one embodiment a thumbnail may be extracted directly from this de-quantized, transformed frame. In another embodiment, a partial inverse transform may be applied first, then a thumbnail extracted from the partially transformed frame. In this case the thumbnail is a combination of high and low subbands. This is a preferred embodiment.

In either case, the thumbnail is saved for later use as the reference thumbnail for subsequent video frames. The thumbnail and sketch may be further transformed, quantized, entropy coded, packetized and transmitted over a packet-switched network, e.g., a cellular phone network. Alternatively, or in addition, the encoded initial frame may be written to memory for later use.

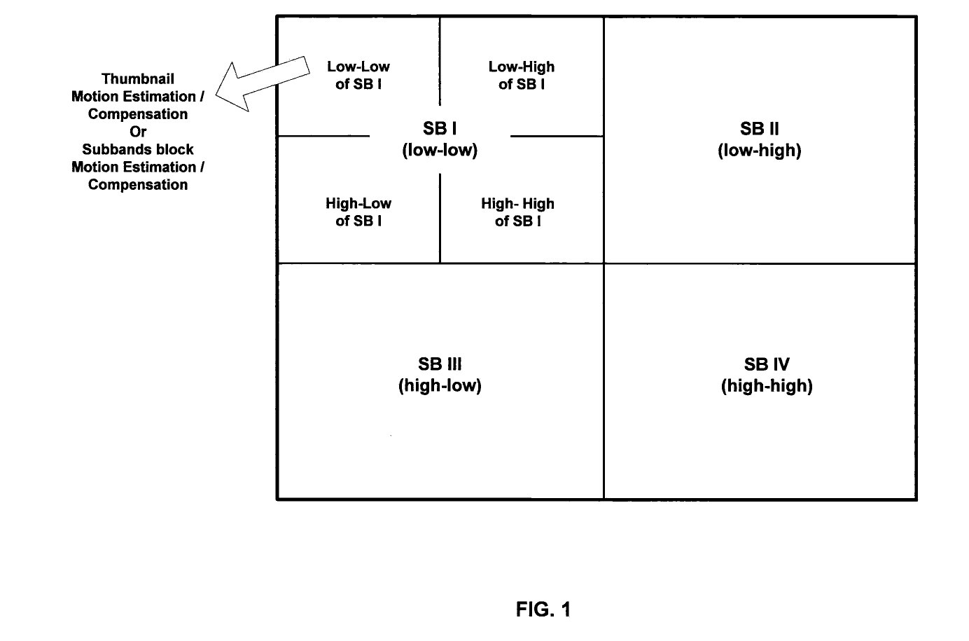

The encoder's processing of any frame following the initial frame of a GOP may proceed as depicted in FIG. 2B. The first step is to apply a transform to the video frame. The output structure of this transform is depicted in FIG. 1. The sketch portion of this transformed video frame may be sent directly to an energy quantization module, depicted as a “Q” in the drawings, and then entropy encoded. The thumbnail is encoded further by motion estimation and compensation. A reference thumbnail (output from a previously processed frame) is used to compute a residual thumbnail which replaces the thumbnail output from the first transform, thereby significantly decreasing the bits per pixel, at least for most video sequences. The residual thumbnail is encoded further by a second transform step, quantization, and entropy coding.

An H.264 type scheme for computing and then transforming residuals may be adapted for use with a thumbnail in view of the disclosure. In one embodiment, H.264 is applied to the thumbnail. That is, after each thumbnail is computed, it is motion compensated (using previous thumbnails), transformed by DCT, quantized and entropy encoded.

In other embodiments, conventional video CODECs such as MPEG-4, H.263, or proprietary CODECs such as VP7 (On2 Corporation), can be applied to the step of processing the thumbnail for compression within the overall scope of this invention.

In alternative embodiments a wavelet-based transform is used. According to these embodiments all residuals are computed and then placed within a temporary thumbnail. This “thumbnail of residuals” contains the collection of residual blocks computed from the motion compensation.

Residuals and their associated motion vectors may be computed in the following manner. First, the estimated motion of the closest-matching block from the prior frame is determined using inter-frame motion estimation—compensation technique. Computationally this adopts the assumption that the block from the previous frame that is most similar to a block in the current frame is the block that also has the lowest sum of the absolute values of the differences (or SAD, for short) of the pixel values for the block of the current frame being processed. The blocks compared to the current block may be selected by shifting the block from the current frame one or more pixels up, down, sideways, diagonally, etc. and at each block position computing the SAD from the differences of the overlapping pixel locations. Thus, if a current block is compared to “N” corresponding blocks from the reference thumbnail, then the most similar prediction block would be the block among the N blocks having the lowest SAD. The motion vector would then locate the new location of the prior block in the current thumbnail. Once an initial block has been found by this process, adjacent blocks in the current thumbnail may be found using intra-frame prediction methods, e.g., by making the assuming that frames adjacent the most similar block are also the most similar blocks for frames adjacent the current block.

The measure of block similarity, SAD, may in other embodiments be replaced with other measures, such as Mean-Removed-SAD or Sum-of-Transformed-Differences.

As mentioned earlier, a difference between the H.264 method for motion estimation and compensation and the alternative method is the transform and encoding stage, i.e., all at once or each block at a time. A disadvantage of H.264 and similar methods is higher computational costs. There are more computational cycles required to produce less bits per thumbnail after quantization, and there are more computational cycles required to operate the de-blocking filters in the encoder and the decoder to avoid visible block artifacts. An advantage of the alternative embodiment is that there is much less computations needed when all of the residuals are transformed at once, as opposed to individually. A disadvantage is less energy compression. Essentially, when transforming a collection of residuals it may sometimes not be possible to compress energy to a low-frequency end. Instead, there can be significant high-spatial frequency content remaining from the transform since the residuals are differences between frames.

Referring once again to FIG. 2B, after transformation of the residuals, whether individually or collectively as a thumbnail of residuals, the transformed residuals are quantized and then entropy encoded. A copy of the quantized residuals is de-quantized and then an inverse transform is applied to produce a predicted thumbnail. This thumbnail will be used as the reference thumbnail for the next video frame. As mentioned earlier, a quantized, then de-quantized thumbnail is used, as opposed to the actual thumbnail output from the initial transform, so that the reference thumbnail used compute the next predicted thumbnail is exactly the same as the reference thumbnail used by the decoder (see FIG. 3B). The actual thumbnail output from the initial transform may be used instead. It is presently preferred, however, that a quantized version of the thumbnail is used instead.

The entropy encoded thumbnail and sketch, i.e., the encoded predicted frames, may be packetized and transmitted over a packet-switched network, e.g., a cellular phone network. Alternatively, or in addition, the encoded predicted frames may be written to memory for later use.

The entropy encoded thumbnail and sketch, i.e., the encoded predicted frames, may be packetized and transmitted over a packet-switched network, e.g., a cellular phone network. Alternatively, or in addition, the encoded predicted frames may be written to memory for later use.

The aforementioned encoding scheme may be applied separately to the chroma and luma components of an incoming video stream.

In a preferred embodiment the encoder processes a plurality or group of frames (GOP) starting with an initial frame followed by a number of subsequent frames, e.g., 14 frames. A reference thumbnail according to this embodiment may be one or more thumbnails associated with prior frames. After the 14th predicted thumbnail has been computed and encoded (FIG. 2B), a new initial frame is found. Thus, for a 15 GOP embodiment, the process of FIG. 2A is used for the 1^{st}, 15^{th}, 31^{st}, etc. I-frame or initial frame and the process of FIG. 2B is followed for the P-frames or all frames other than the I-frames. The number of frames in a GOP may be allowed to vary rather than being fixed.

FIGS. 3A-3B depicts schematically a description of the principal steps associated with decoding video data according to the disclosure. The decoding of the initial video frame is depicted in FIG. 3A, while the decoding of subsequent video frames is depicted in FIG. 3B. As was the case for FIGS. 2A-2B, it will be understood that the depictions in FIGS. 3A-3B do not necessarily convey a particular organization of software-implemented logic or arrangement of hardware.

FIGS. 3A and 3B illustrate processes for decoding, respectively, the initial frame data and subsequent, predicted frame data, which may arrive as a bitstream of packetized data or may be read from memory. The first step is to unpack the data, followed by entropy decoding and de-quantization. The decoded thumbnail portion of the initial frame is saved for later use as a reference thumbnail for re-constructing thumbnails of subsequent video frames.

Referring to FIG. 3B, there are two decoding steps needed to decode a predicted video frame. The first is the inverse transform for the thumbnail of residuals, followed by the decoding of the motion estimation/compensation portion of the encoder. Thus, the thumbnail of residuals, reference thumbnail and motion vectors are combined to reconstruct a predicted thumbnail for the current frame. After this step is complete, the thumbnail and sketch are combined and the inverse transform is completed. The reconstructed, predicted thumbnail is saved for later use as a reference thumbnail for the next frame.

Quantifying the Performance of a CODEC

A Total Merit, or Rate-Distortion-Complexity (RDC) rating may be defined to evaluate a CODEC. A RDC rating is intended to express the overall quality of a CODEC as based on its compression ratio, e.g., bits per pixel, the amount of distortion in the image produced from the decoded data, e.g., PSNR value, and a complexity factor, e.g., number of computational cycles, calls to memory, etc. A RDC may be expressed in various ways. In general, the three part measure of quality in a CODEC, i.e., the RDC rating, may be defined as: (1) Video Rate (compressing to a usefully small number of bits); (2) Video Quality/Distortion (getting a result that is useful and valuable to viewers); and (3) Processing Complexity (getting the job done within the available computing resources). An RDC may be expressed graphically. For example, in a graphical sense a RDC rating for a CODEC may be expressed in three-dimensional space as a point located above an imaginary plane, where the three normal axes are compression rate (r), distortion (d) and complexity (c). These terms are discussed in greater detail, below.

Alternatively, a performance of a CODEC may be defined in terms of inequalities for the R, D and C terms. For example, a CODEC may be qualified as superior when its R, D and C, for a given video type, frame rate, etc. and operating platform, satisfy's the each inequality R<R′, D<D′ and C<C′ where R′, D′ and C′ are defined by some standard, as discussed above.

A dimensionless “bits per pixel” (bpp) holds for any size and timing and is more convenient. This may be used as an expression of rate (R). The measurement of quality (Q) is explained next.

The “D” Measure of a CODEC

In general, distortion or quality of a viewed image is measured by two methods, which may be understood as Objective vs Subjective. The ultimate goal for the D metric is to quantify a subjective satisfaction of human users. One procedure for subjective quality determination is a measurement known as MOS “Mean Opinion Score”. For the present, we will only consider “objective” measures for assessing D. (Quality or amount of distortion).

Objective measures compute some function of image data that is intended to be an estimate of human evaluations. Common objective measures are Delta, MAD, MSE, PSNR, VQM, SSIM, which are well known in the art. All of these measures are referred to as Full Reference measures, since they require both the processed result and the unprocessed original data for the computation. Other measures are referred to as Non Reference measures, since they operate on the processed result without using the original. For video CODEC evaluation, the processed data being measured is the result of applying the encoding (or compression) operation to some source video material, followed by applying the decoding (or decompression) operation to the encoded material. This is the video material that will be seen by a user of the system and is the appropriate thing to measure for quality. A Delta metric for D simply takes the original and the processed data, frame by frame, and within each frame subtracts each pixel of the processed data from the corresponding pixel of the source data. The differences are averaged over all pixel positions in the data sequence.

MAD “Mean Absolute Difference”. Like Delta, subtracts pixel-by-pixel, but takes the absolute value of each difference before averaging. This avoids cancellation between positive errors and negative errors. MSE “Mean Squared Error”. Like MAD but instead of absolute value, squares each difference before averaging. This is a widely used metric for D. PSNR “Peak Signal to Noise Ratio”. This is a logarithm of MSE. For this measure, higher numbers indicate a better result (closer match to original). This is the most widely used measure, but sometimes poor correlation with human opinion scores. VQM “Video Quality Measure” is from Sarnoff Labs, commercialized by Tektronix and others.

SSIM “Structural Similarity Measure” is another metric. Many other measures have been proposed or defined.

The “C” Measure of a CODEC

For a computational algorithm, basic complexity measures involve counting the arithmetic operations and the memory access (copying) operations required. These operations are in practice implemented using the instructions of some computer processor and memory system. For example, the ARM926EJ-S processor and memory [ref ARM] operates according to the ARMv5E computer architecture definition [ref ARM]. This is a RISC (Reduced Instruction Set Computing) architecture with load, store, and register operation instructions. In practice, the commercial advantage of a faster, lighter weight, more efficient implementation is measured by the number of cycles taken by execution of the algorithm implementation on some particular computer, such as the ARM-9E.

It is possible to operate algorithms on computers that have cycle-counting and measurement circuits or capabilities built in or added on. The results published in APPENDIX B were obtained from a platform having this circuitry. While particular embodiments of the present invention have been shown and described, it will be obvious to those skilled in the art that changes and modifications can be made without departing from this invention in its broader aspects. Therefore, the appended claims are to encompass within their scope all such changes and modifications as fall within the true spirit and scope of this invention.

### Examples

A measuring standard for CODEC performance is the peak-signal-to-noise ratio (PSNR) for the luma component of a video signal. Similar standards for assessing compression quality are set forth or endorsed by the Video Quality Experts Group (VQEG). See http://www.its.bldrdoc.gov/vqeg (downloaded Nov. 26, 2008).

Using the platform defined in APPENDIX D and the “New_Suzie” video defined in APPENDIX C, a QRC or Total Merit was computed for a CODEC according to the invention. The results of these tests are reproduced as APPENDIX B.1 and B.2, as follows: B.1 is for the VGA (=640×480 pixel image size) measurement case; B.2 is for the QCIF (=176×144 pixel) case. For C (Cycles), the boldface lines present the complexity measure for eth CODEC. They are expressed in three ways:
Total CPU Cycles:
Cycles/frame:
Cycles/pixel:

For R (Rate), the boldface lines are
File Size [bytes]
Bits-per-Pixel [BPP]

For D, there are two measurements (PSNR and MSE) made on three components (Y=luma, U=blue chroma, and V=red chroma). The data expressing a quality measurement are found under the boldface columns
MSE_YYUV
   Avg:
MSE_UYUV
   Avg:
MSE_VYUV
   Avg:

Main emphasis is typically placed on the Y measurement. However, it is contemplated that a U or V value, viewed separately or together with Y ay also be used as a measure of Q. Based on the above preferred conventions, a lower value for QRC is more desirable. For the video data results in B.1 the product RDC is 50.161*0.032578*23.898=39.05. For the RDC product for B.2 is 35.882*0.200915*42.6909=307.77.

Using a CODEC on a System Having a MMSS

Referring to APPENDIX A, one use of the CODEC disclosed herein is for editing compressed video data at a network computer without first applying an inverse transform, e.g., an inverse wavelet transform. When video is stored and transmitted, it is conventionally in a compressed format. This is for good reason because storage and transport of bits is expensive; the costs of storage and transmission are reduced by the compression ratio. Video is often subjected to editing operations, such as cut, splice, fade-to-black, cross-fade, overlay, etc. When these operations are applied to compressed representations of video, some of them conventionally require that the video be decompressed (decoded) into pixels: (a plain or displayable form) for the editing operations, then the edited result to be compressed (re-compressed) for further transmission or storage.

When edited in the pixel domain, many important operations require computation to be applied to every pixel. For example, fade-to-black requires that each pixel be subjected to an operation changing its value to be nearer to black; this must be repeated on each frame in the fading interval. With CODEC according to the invention, many of these editing operations can be performed without completely decoding to pixels. Instead we decode partially into a “transform domain” representation. In this representation, we can for example for a fade-to-black operation by operating on many fewer values (numbers) than the pixels. In one embodiment there is fade-to-black by operating on 1/256 of the values in the transform-domain image for each frame in the fade interval.

Additional Aspect of the Present Invention—Low-Band Side Pyramid for Hierarchical Motion Estimation and Magnitude Motion Compensation

In a 2D+T wavelet video codec, we add the step of saving the low-low subband at each 2D stage of the wavelet transform, and use the saved images for hierarchical motion estimation by block search. This avoids the problems of matching in wavelet high-pass subbands.

We can use the final set of motion vectors to motion compensate all subbands conventionally. Optionally we apply a variant motion compensation that exploits greater correlation between the magnitudes of highpass coefficients than between their signed values. To do this we take as residual the difference of absolute values of the current and reference, and transmit the sign of the current value separately.

An additional aspect of the present invention comprises a novel approach to motion estimation and magnitude motion compensation. In this approach, wavelet transforms are applied to each frame in a pyramid sequence: a wavelet filter pair transforms the frame horizontally into a low-pass and a high-pass part, each of half the original size; then the wavelet filters transform the result vertically, resulting in four subbands totaling the same size as the original frame. An example of this is shown in FIG. 1 as subbands SB I, SB II, SB III, and SB IV and may be termed to illustrate the subbands of a 2-level transform, or a 2-level pyramid. An additional pair of wavelet transforms may be applied to SB I to generate the subbands of Low-Low of SB I, Low-High of SB1, High-Low of SB I, and High-High of SB I shown in FIG. 1. The subbands shown in FIG. 1, can then be said to illustrate the subbands of a 4-level pyramid.

In certain embodiments of the Low Band Side Pyramid invention described herein 4, 6, 8, or 10 or more level pyramids may be used. In the present embodiment, the subband termed low-low is saved after each sequential 2-level transform is performed. As an illustration, then, subband SB I would be saved after the first 2-level transform was performed. Next, the Low-Low subband of SB I would be saved after the next 2 level transform was performed (on SB I). In similar fashion, the low-low subband of each of the succeeding 2-level transforms would be saved. This would result in a pyramid of saved (successive) low-low subbands with each corresponding to a different level of transform. This pyramid of saved low-low subbands is termed a “side pyramid” —a pyramid of the successive low-low subbands resulting from wavelet transforms of the frame—for discussions herein. This successive transform process with saving low-low subbands can be carried out on a reference frame of a video. It will be understood that each of the low-low subbands comprises an image of the original frame and can be termed itself an image.

For reference to this embodiment, a “higher” level subband means a subband which is the result of a greater number of wavelet transforms on a frame than a “lower” level subband which is the result of a lesser number of wavelet transforms on a frame. Thus the low-low subband of an 8th-level transform is designated a “higher” level subband than the low-low subband of a 4th-level transform of the same frame.

Additionally wavelet transforms are conducted on a temporally succeeding frame (to the reference frame), termed the “current frame”, to generate not only pyramid of an equal level but also a pyramid of saved (successive) low-low subbands with each corresponding to a different level of transform carried out on the temporally succeeding or current frame.

By the process of successive wavelet transforms on the reference and succeeding frames, or current frame, a side pyramid is obtained for each of the reference and succeeding/current frames.

Motion estimation is conducted between the reference frame and the temporally succeeding frame (current frame) by block motion estimation between a selected low-low subband of the reference frame and the low-low subband of the same level of the temporally succeeding frame. (Each of these low-low subbands is part of the side pyramid of the respective frame.) In this step the images of the low-low subbands are taken one block at a time and for each block of the current image, a position in the previous (reference) image is chosen as the predictor. The process of choosing a prediction block is block matching motion estimation (“ME”), and works by considering a range of possibilities for the reference block to be chosen. Typically the choice depends on a measurement of matching and of the cost of coding the choice.

Matching more closely is beneficial in that it reduces the number of bits required to convey the residual difference or change from image to image; but we must also convey the choice of predictor block. In our simple scheme this is a motion vector (MV) which is simply the offset, horizontally and vertically, of the chosen predictor block in the reference image from the current block position

It is possible to choose a motion vector that refers to a sub-pel location; in this case, the reference block may be calculated by interpolating the pels (samples) of the reference to give an approximate in-between block.

After the wavelet transform is done and the side pyramid constructed, we have available a set of images upon which to conduct hierarchical motion estimation.

Optionally, we can use the saved reference image at the next-larger level in our motion search. This lets us compute a half-pel accurate motion vector without spending any effort interpolating pixels to use in the half-pel matching.

Possibly even the larger image at the level beyond can be used for quarter-pel MV refinement.

We then use the resulting MVs from each level to motion compensate all wavelet subbands at same level, accomplishing the goal of applying temporal prediction to compress the video sequence. Notice that we do not code or transmit the saved images of the side pyramid; they are only used to aid in the ME prediction of the wavelet pyramid.

In some embodiments, not every level of low-low subbands is saved, but only selected levels of subbands are saved. Additionally and similarly, in some embodiments only selected levels of low-low subbands are compared for motion estimation and or magnitude motion compensation.

Magnitude Compensation (“MC”).

Conventional motion compensation consists of simply subtracting the chosen reference predictor block, point by point, from each block of the current frame in the encoder, yielding a residual to be transmitted, and adding the same reference block to the received residual in the decoder. But because of the shift-variance of wavelet coefficients, this simple MC may not give the best compression.

We expect that wavelet highpass coefficients will tend to be of large magnitude at corresponding places in successive frames, even when they are altered by shift induced variation so far as to reverse their sign.

So we may get better prediction and smaller residuals by compensating only the magnitude of these coefficients, ignoring the sign (and transmitting the sign separately).

To do this we take a coefficient P in the predictor block and the corresponding coefficient C in the current image block, calculate the absolute value of each, and subtract the reference from the current. The result is a signed residual as usual.

We must also transmit the sign of C, as it is not represented in the residual. This procedure may be of advantage when the statistics of coefficients are like those of an amplitude subjected to a random phase.

In the decoder, we add the received signed residual to the absolute value of the reference, and then we apply the separately received sign bit to the result.

While particular embodiments of the present invention have been shown and described, it will be obvious to those skilled in the art that changes and modifications can be made without departing from this invention in its broader aspects. Therefore, the appended claims are to encompass within their scope all such changes and modifications as fall within the true spirit and scope of this invention.

What is claimed is:

1. A mobile device, comprising
an imager; and
a CODEC resident on computer-readable media and configured to run on the imager, the CODEC receives as input uncompressed video data and produces video data in a compressed format;
wherein the output compressed video data is produced having the same quality and bit-rate and about a 40% reduction in the number of computational cycles per frame over a H.264 CODEC using the same imager.

2. The mobile device of claim 1, wherein the imager and CODEC process VGA video at 30 frames per second and produce a compressed data rate of less than 800,000 bits per second.

3. A video stream stored on a computer-readable medium and capable of producing a video sequence, the video stream comprising:
a group of pictures, wherein a first picture includes a sketch and a thumbnail and a second picture includes a reference thumbnail that is used to create a predicted thumbnail from the residual and motion vector.

4. The video stream of claim 2, wherein a frame of the group of pictures consists of a sketch and an encoded thumbnail comprising the residual and motion vector, and wherein the sketch is a subband product of a wavelet transform.

5. A system for sending a video sequence over a network, comprising:
a first device having a processor configured to apply a transform to uncompressed video data to produce a thumbnail and a sketch, and then encode the thumbnail to produce a residual and motion vector portion of the thumbnail; and
a second device configured to transmit the encoded sketch, residual and motion vector over a network.
